(19) United States
(12) Patent Application Publication
(10) Pub. No.: US 2013/0220281 A1
(43) Pub. Date: Aug. 29, 2013

(54) METHOD, ENGINE CYLINDER, AND ENGINE WITH OPPOSED SEMI-LOOP SCAVENGING

(71) Applicant: FRANZ J. LAIMBOECK, GOLETA, CA (US)

(72) Inventor: FRANZ J. LAIMBOECK, GOLETA, CA (US)

(73) Assignee: MAHLE KOENIG KOMMANDITGESELLSCHAFT GMBH & CO KG, RANKWEIL (AT)

(21) Appl. No.: 13/604,824

(22) Filed: Sep. 6, 2012

Related U.S. Application Data
(60) Provisional application No. 61/531,373, filed on Sep. 6, 2011.

(51) Int. Cl. F02B 25/14

(52) U.S. Cl. CPC F02B 25/14
USPC 123/51 BD

(57) ABSTRACT

A method for the reverse scavenging of an engine cylinder and for the introduction of fresh gas into the cylinder and for the discharge of exhaust gas out of the cylinder. The cylinder has oppositely disposed and opposingly driven pistons. In the region of the respective bottom dead center (BDC) of the two pistons, there are formed in the cylinder wall in each case one outlet region for the exhaust gas and in each case one, in particular circumferentially opposite flow transfer region for pre-compressed fresh gas which has been admitted from the crankcase. The fresh gas supplied through the respective flow transfer region is expelled in the direction of the wall region which is situated on that side of the cylinder inner wall and which adjoins the flow transfer region in the cylinder longitudinal direction.

### CROSS-REFERENCE TO RELATED APPLICATION

This application claims the benefit under 35 U.S.C. §119(e), of provisional patent application No. 61/531,373 filed Sep. 6, 2011; the prior application is herewith incorporated by reference in its entirety.

### BACKGROUND OF THE INVENTION

### Field of the Invention

The invention relates to a method for the reverse scavenging of an engine cylinder and for the introduction of fresh gas into the cylinder and for the discharge of exhaust gas out of the cylinder, in which cylinder are arranged oppositely situated and opposingly driven pistons, and in the region of the respective bottom dead center (BDC) of the two piston, there are formed in the cylinder wall in each case one outlet region for the exhaust gas and in each case one, in particular circumferentially opposite flow transfer region for pre-compressed fresh gas which has been admitted from the crankcase.

The invention also relates to an engine cylinder having two opposite, opposingly driven pistons, wherein in each case one outlet region for exhaust gas and in each case one flow transfer region for fresh gas supplied from the crankcase are formed in the region of the bottom dead center (BDC) of each of the two pistons, wherein the outlet region and the flow transfer region of each piston are formed in each case in a separate, delimited circumferential portion of the cylinder inner wall.

### SUMMARY OF THE INVENTION

It is an aim of the invention to improve the operation and the efficiency of engine cylinders and/or of engines having cylinders according to the invention. The design and construction of an engine having such cylinders should be simple and inexpensive. The engine should operate in as quiet and vibration-free a manner as possible. Furthermore, the gas exchange should be efficient.

A method according to the invention provides that the fresh gas supplied through the respective flow transfer region is expelled in the direction of the wall region which is situated on said side of the cylinder inner wall or in said half-cylinder and which adjoins the flow transfer region in the cylinder longitudinal direction.

A cylinder according to the invention is characterized in that the two outlet regions for the exhaust gas, which are situated in the respective bottom dead center regions of the pistons, are arranged offset with respect to one another by 180° about the cylinder circumference, in that the two flow transfer regions for fresh gas which are situated in the respective bottom dead center regions of the pistons are arranged offset with respect to one another by 180° about the cylinder circumference, and in that each flow transfer region has a number of flow transfer windows which are formed in the cylinder inner wall and by means of which the fresh gas supplied from the crankcase is admitted in a directed manner in the direction of a wall region which is situated on said side of the cylinder inner wall and which adjoins the respective flow transfer region in the cylinder longitudinal direction.

As a result of the guidance according to the invention of the fresh gas in the direction of a wall region of the inner wall surface of the cylinder, which wall region is situated on one side of the cylinder inner wall and which extends in the longitudinal direction of the cylinder, it is achieved that the two gas flows formed in the opposite cylinder parts do not disrupt one another, and an optimum discharge of the exhaust gases is achieved. The flow transfer and outflow take place efficiently and without disruption, such that the efficiency of the engine cylinder and/or of an engine having at least one such cylinder is improved.

It may advantageously be provided that the fresh gas is admitted in the direction of the central region of the longitudinal half, which is situated opposite the respective outlet region, of the cylinder inner wall or of the wall region.

It is particularly advantageous if, by means of the fresh gas which has been admitted in the direction of said wall region and which has been guided longitudinally along the cylinder inner wall of said cylinder half, the exhaust gases from the previous combustion stroke which are situated in the region in front of said cylinder inner wall are forced into the outlet duct situated in the region of the bottom dead center of the opposite piston. As a result of the concentration of the admitted fresh gas on a wall region whose circumference advantageously amounts to approximately half of the cylinder circumference, the admitted fresh gas moves along the cylinder inner wall in one longitudinal half of the cylinder and forces the exhaust gas situated in said region of the cylinder out of the cylinder through the exhaust duct.

To prevent a collision of the two fresh-gas flows guided in opposite directions in the cylinder, it is expedient if, in the cylinder, during the admission of fresh gas via the two flow transfer regions, two gas flows which are directed toward one another and which flow in each case along opposite cylinder inner wall surfaces are guided in the direction of the outlet region formed in each case in said cylinder inner wall surface.

A cylinder according to the invention is characterized in that the two outlet regions for the exhaust gas, which are situated in the respective bottom dead center regions of the pistons, are arranged offset with respect to one another by 180° about the cylinder circumference, in that the two flow transfer regions for fresh gas which are situated in the respective bottom dead center regions of the pistons and in each case opposite the connection regions are arranged offset with respect to one another by 180° about the cylinder circumference, and in that each flow transfer region has a number of flow transfer windows which are formed in the cylinder inner wall and which together, or in interaction, admit the fresh gas supplied from the crankcase in a directed manner in the direction of a wall region which is situated on said side of the cylinder inner wall and which adjoins the respective flow transfer region in the cylinder longitudinal direction.

The design of the cylinder according to the invention is simple because the two component cylinders which are separated from one another by a central plane running perpendicular to the longitudinal axis of the cylinder can be produced so as to be of identical, mirror-symmetrical form, and need merely be arranged, and assembled, with a rotational offset of 180° with respect to the cylinder longitudinal axis. It is possible for two identical half-cylinders to be produced and connected to one another, for example by means of integrally formed screw flanges. In practice, a cylinder of said type may also be a cast part which is constructed in one piece, wherein the respective outlet regions and flow transfer regions are situated in the respective regions of the bottom dead centers with centric symmetry.

To be able to optimally concentrate the fresh gas flows on in each case one of the two longitudinal half portions of the cylinder, it is expedient if the provided flow transfer windows, by interaction, generate the flow of the fresh gas and direct it if appropriate toward a portion of the wall region of the cylinder inner wall, which portion is situated centrally in said wall region. Through corresponding design of the flow transfer windows, that is to say of the wall surfaces which delimit the flow transfer windows or the alignment thereof, it is possible to attain such a flow of the fresh gas.

It is advantageous if each of the flow transfer windows provided in the two flow transfer regions is delimited by wall surfaces which predefine for the flow transfer windows an outflow direction which runs in the direction of the wall region adjoining the respective flow transfer region.

For the operation and the production of the cylinder according to the invention, it is advantageous if the cylinder exhibits centric symmetry with respect to the respective flow transfer region and outlet region assigned to in each case one of the two pistons.

If no auto-ignition of the fuel-air mixture is provided, it may be provided that ignition units and/or fuel injection units and/or fuel feed units open out in the circumferential region situated in the longitudinal center of the cylinder.

A cylinder which is substantially vibration-free, which is simple to produce, which permits an optimum gas movement and an efficient charge exchange with low scavenging losses is provided if the outlet ducts extending from the outlet regions of the cylinder are connected to an exhaust system, and during the time period in which the outlet ducts are opened up by the respective piston, the pressure waves running in the direction of the silencer and back are in resonance with the opening duration of the outlet windows.

For the combustion process, it is furthermore advantageous if the cylinder, with respect to a central plane perpendicular to the cylinder longitudinal axis, forms two component cylinders which are identical, of mirror-symmetrical construction but rotationally offset with respect to one another by 180° about the cylinder longitudinal axis, and/or if the flow transfer windows and the outlet windows are formed so as to be symmetrical with respect to a longitudinal central plane, which is perpendicular to the piston pin and which comprises the cylinder longitudinal axis, of the cylinder.

The invention also relates to an opposed-piston engine which comprises two cylinders according to the invention combined to form an overall cylinder.

Other features which are considered as characteristic for the invention are set forth in the appended claims.

Although the invention is illustrated and described herein as embodied in an opposed semi-loop scavenging, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an opposed-piston engine in a section which encompasses the longitudinal axis of the cylinder and the piston. The illustrated section follows the single plane of symmetry of the cylinder according to the invention or opposed-piston engine.

FIG. 2 shows an opposed-piston engine in section with in each case four flow transfer windows in the bottom dead center region of the cylinder.

FIG. 3 shows a line drawing or a section approximately at the mid-height level of the cylinder as per FIG. 2.

FIG. 4 shows a line drawing or a section approximately at the mid-height level of the cylinder through a cylinder with four outlet windows and seven flow transfer windows, with cooling ducts running in the wall of the cylinder.

### DETAILED DESCRIPTION OF THE INVENTION

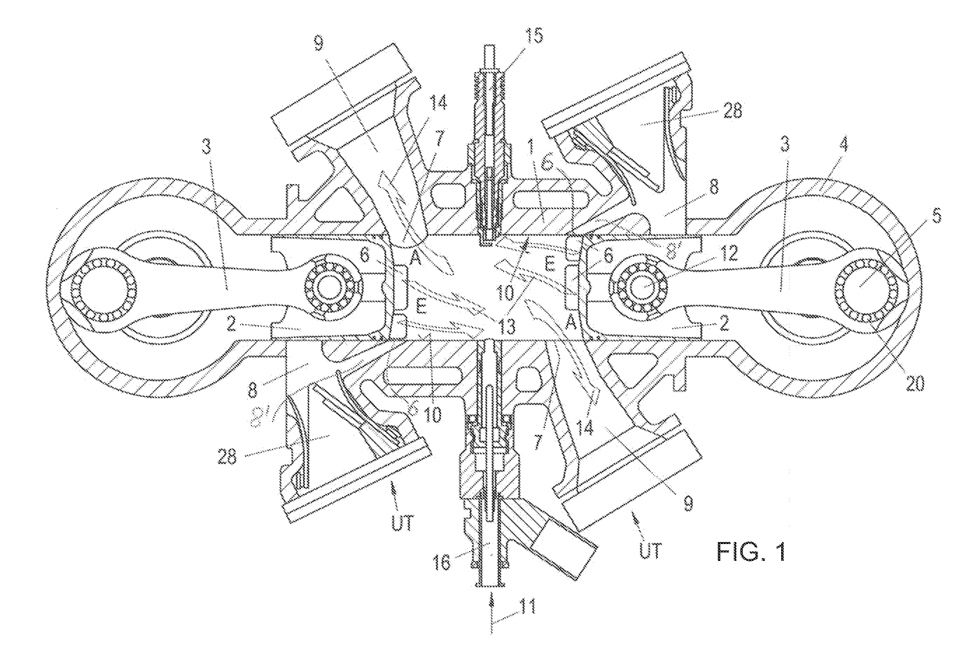

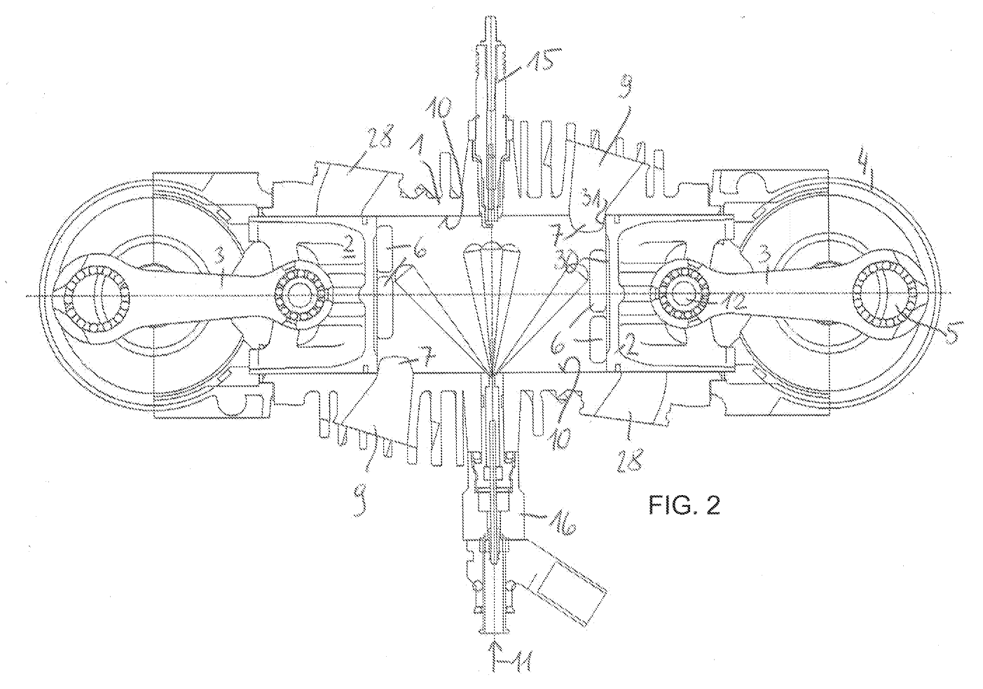

The cylinder or engine according to the invention operates on the principle of reverse scavenging, specifically opposed reverse scavenging in each case for the longitudinal half of the cylinder volume. As per FIGS. 1 and 2, two opposingly driven pistons 2 are mounted in the cylinder 1 such that they can move up and down. Each piston 2 has a connecting rod 3 which is articulatedly connected to a piston pin 12 and which is connected via a bearing 20 to the crankshaft 5 and drives the latter. The crankshaft 5 is rotatably mounted in a crankcase 4. In the crankcase 4, fresh gas, that is to say air or a fuel-air mixture, which flows in via an inlet duct 28 is pre-compressed and admitted via at least one flow transfer duct 8 via at least one flow transfer window 6 into the interior of the cylinder 1. Each of the five flow transfer windows 6 provided in FIG. 1 is fed by one flow transfer duct 8 or 8′. In the drawing, the pistons 2 are illustrated in their bottom dead center position BDC. It is provided that the fresh gas which is supplied through the respective flow transfer region E flows in the direction 13 of the wall region 10 which is situated on said side of the cylinder inner wall and which adjoins the flow transfer region E in the cylinder longitudinal direction.

The number of flow transfer windows 6 is variable; it is advantageous for three, four or five flow transfer windows 6 to be formed in a circumferential region, which constitutes a flow transfer region E, of the cylinder inner wall, which flow transfer windows are fed by flow transfer ducts 8, 8′. FIG. 1 also shows the centrally situated flow transfer window of the five flow transfer windows 6 provided, to which flow transfer window leads the flow transfer duct 8′. In the circumferential region which is free from flow transfer windows 6, there is arranged in an outlet region A at least one outlet window 7 which adjoins an outlet duct 9. Each piston 2 closes off the flow transfer windows 6 and the outlet window 7 for a certain time, and opens up the flow transfer windows 6 and the outlet window 7 when the piston 2 is situated in the region of the bottom dead center BDC.

It is essential for the engine function according to the invention that all of the flow transfer windows 6 provided, through corresponding alignment of their delimiting walls, jointly expel the fresh gas supplied through the flow transfer windows 6 in a directed manner toward a wall region 10 of the cylinder inner wall surface, which wall region is situated in that region of the cylinder inner wall surface which is situated adjacent to the flow transfer windows 6, that is to say adjoining the latter in the cylinder longitudinal direction. The direction of expulsion of the individual flow transfer windows may vary; it is essential that the overall flow of the supplied fresh gas flows in the direction of the wall region 10. In particular, the expulsion of the fresh gas through the flow transfer windows 6 takes place into the central region of that wall region of the cylinder inner wall surface which adjoins the flow transfer windows 6 in the longitudinal direction, such that the expelled fresh gas moves along the wall region 10 in the direction 13 of the outlet window 7 formed in the bottom dead center region BDC of the opposite piston 2. As a result of the admission of the quantity of fresh gas along the arrows 13, the exhaust gas remaining from the preceding combustion stroke is forced along the arrows 14 into the respective outlet duct 9.

The two fresh-gas flows 13 flow past one another in each case along mutually opposite wall regions 10 of the cylinder inner wall surface, without generating significant contact or turbulence in the contact region. An optimum gas exchange in the cylinder 1 is thus attained.

The inclination of the individual wall surfaces of the flow transfer windows 6 which delimit the flow transfer windows 6 is configured so as to vary, specifically such that the flow transfer windows 6 together conduct the respectively admitted fresh gas to the wall region 10, specifically into a region which begins at the position of the respective flow transfer window 6 in the cylinder inner wall surface in the BDC region and ends approximately in the central region 11 of the cylinder 1. From said region onward, a flow 13 is generated which runs approximately parallel to the wall surface. In this way, a collision of the gas flows supplied through the flow transfer regions E, which are situated in the in each case mutually opposite bottom dead center regions and so as to be rotationally offset with respect to one another by 180°, is prevented, and the remainder of residual gases in the cylinder 1 is minimized. The alignment of the outflow directions of the individual flow transfer windows is such that the resulting fresh-gas flow moves in the direction of the arrows 13.

During the course of the reverse scavenging which takes place in the region of the bottom dead center of the respective piston 2, that half of the cylinder 1 which is situated opposite that outlet window 7 in the BDC region through which exhaust gas is simultaneously discharged is filled with fresh gas. This is achieved by means of the described formation of the flow transfer windows 6 or of the delimiting wall surfaces of the flow transfer windows 6.

A direct injection of fuel is expediently provided in the region of the top dead centers of the two pistons 2, that is to say in the central region 11 of the cylinder, because scavenging losses of fuel can be eliminated this way. In this case, the inherently unavoidable scavenging losses in a two-stroke engine according to the invention would consist merely of supplied air.

Also possible, however, is the implementation of a semi-direct injection from the cylinder wall or through a flow transfer duct. A semi-direct injection can take place with relatively low rail pressure, such that a high-pressure injection pump is not required. An injection into the crankcase is likewise possible, as is an intake pipe injection or the provision of a carburetor in the intake pipe.

A plurality of ignition locations may be formed in the region of the top dead centers.

As can be seen from the drawing, an opposed-piston engine according to the invention is constructed with two component cylinders which are of the same or identical construction and which are attached or connected to one another and which are arranged offset or rotationally offset with respect to one another by 180° about the cylinder longitudinal axis.

The opposed-piston engine according to the invention is of point-symmetrical design, at least with regard to the cylinder wall, the pistons 2, the flow transfer windows 6 and the outlet windows 7, about its central plane 11, aside from the fact that the two motor halves have a rotational offset of 180° with respect to one another.

The exhaust ducts 9 lead to a silencer system, and the pressure pulses of the silencer system, which is in resonance, assist the purging of the cylinder 1, and the pressure pulses returning from the silencer effect an intense rotating movement of the charge mass with associated homogenization of the combustion gas and formation of turbulence in the combustion gas, such that rapid and comprehensive combustion is attained. The outlet ducts 9 are advantageously of identical construction and run separately from one another at least over a part of the manifold region. The silencer system is a resonance exhaust system, that is to say, during the time period in which the outlet ducts 9 are opened up by the piston 2, the pressure waves running from the cylinder 1 to the silencer and the opening duration of the outlet windows 7 are in resonance.

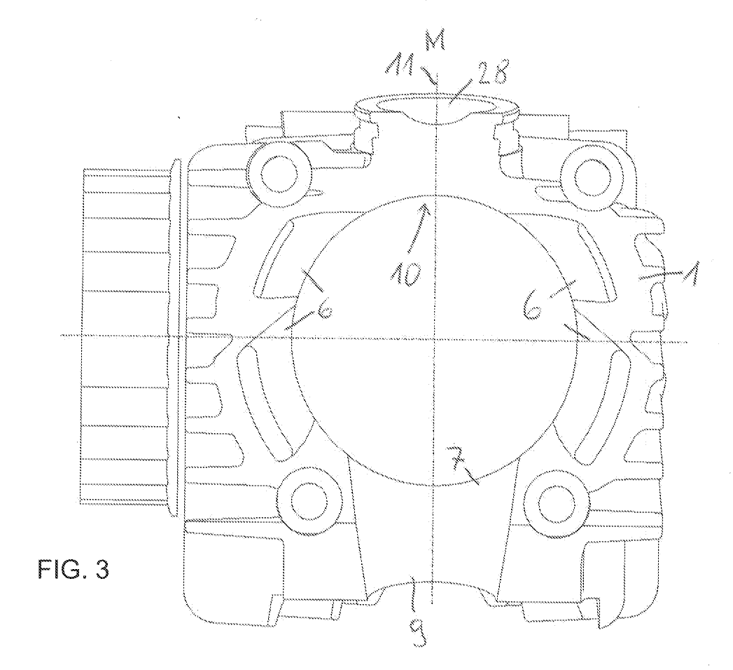

As can be seen from FIG. 3, the flow transfer windows 6 may extend over a circumferential region of the cylinder inner wall surface which is greater than 180° but advantageously less than 270°.

The end surface of the pistons 2 is concavely curved or planar and advantageously has no local depressions or recesses or projections or lugs which impart a direction or movement to the fresh gas or exhaust gas to be compressed. The piston surface is advantageously symmetrical, or at least centrically symmetrical with respect to the piston longitudinal axis.

FIG. 2 illustrates a section through an opposed-piston engine. Said opposed-piston engine is constructed in the same way as the opposed-piston engine illustrated in FIG. 1. What differs, however, is the number of flow transfer windows 6. Five flow transfer windows 6 are provided in the opposed-piston engine illustrated in FIG. 1. The opposed-piston engine as per FIG. 2 has four flow transfer windows 6 which are situated in each case symmetrically with respect to a plane which runs through the cylinder longitudinal axis and which is perpendicular to the axis of the piston pin 12. It can in turn be seen that the outlet duct 7 opens into the interior of the cylinder 1 in the region which is free from flow transfer windows 6.

The end surface of the piston 2 has a depression 30 which is formed at least with centric symmetry with respect to the cylinder longitudinal axis. In the circumferential regions of the end surface, the piston has a planar, circular-ring-shaped circumferential surface 31 which surrounds a central depression.

Fuel is injected in the central region of the cylinder 1 by means of the fuel injection unit 16. An ignition unit 15 is situated opposite the fuel injection unit 16. Air is preferably supplied as fresh gas into the cylinder interior, and fuel is injected by means of the fuel injection unit 16 into the air supplied via the flow transfer windows 6.

In FIG. 3, the single outlet window 7 opens into the outlet duct 9. The flow transfer ducts 8, 8′ are supplied with fresh gas via the inflow duct 28, which flow transfer ducts introduce said fresh gas via the flow transfer windows 6 into the interior of the cylinder 1 in the direction of the wall region 10 of the cylinder inner wall surface. The cylinder 1 is of symmetrical construction about its longitudinal central plane M.

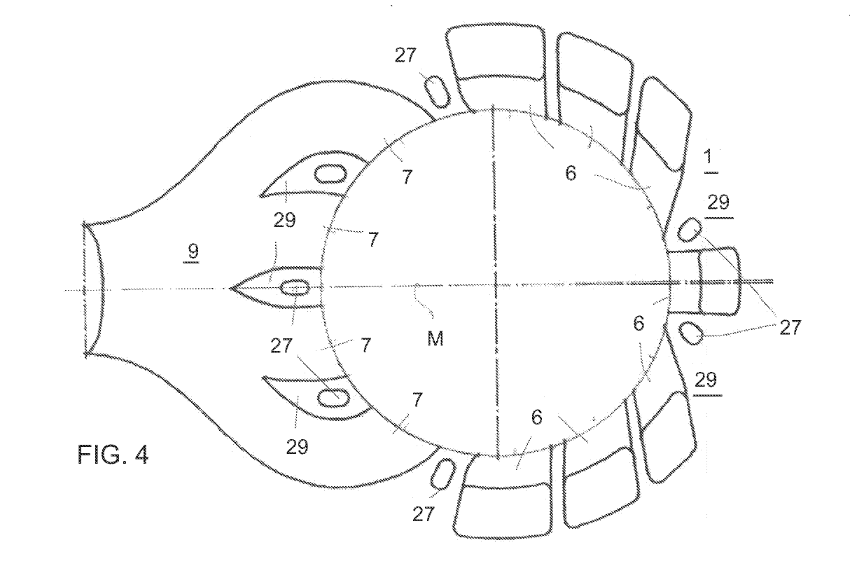

FIG. 4 shows a line drawing at approximately the mid-height level of the duct window. Four outlet windows 7 conduct the exhaust gas into the outlet duct 9. Via the inflow duct 28, fresh gas is introduced via the flow transfer windows 6 into the interior of the cylinder 1. Cooling ducts 27 are formed in a number of wall webs 29 between the outlet windows 7 and/or the flow transfer windows 6. The arrangement and design of the cylinder 1 is symmetrical about the central plane M.

1. A method for the reverse scavenging of an engine cylinder and for the introduction of fresh gas into the cylinder and for the discharge of exhaust gas out of the cylinder, the method which comprises:
providing a cylinder with oppositely situated and opposingly driven pistons, and having, in the region of the respective bottom dead center (BDC) of the two pistons, formed in the cylinder wall in each case one outlet region for an exhaust gas and in each case one, in particular circumferentially opposite flow transfer region for pre-compressed fresh gas which has been admitted from the crankcase;
expelling fresh gas supplied through the respective flow transfer region in the direction of the wall region which is situated on said side of the cylinder inner wall and which adjoins the flow transfer region in the cylinder longitudinal direction.

2. The method as claimed in claim 1, wherein the fresh gas is admitted in the direction of the central region of the circumferential region, which is situated opposite the respective outlet region, of the cylinder inner wall or of the wall region.

3. The method as claimed in claim 1, wherein, by means of the fresh gas which has been admitted in the direction of the wall region and which has been guided longitudinally along the cylinder inner wall, the exhaust gases from the previous combustion stroke which are situated in the region in front of the cylinder inner wall of said cylinder longitudinal half are forced into the outlet duct situated in the region of the bottom dead center (BDC) of the opposite piston.

4. The method as claimed in claim 1, wherein, in the cylinder, during the admission of fresh gas via the two flow transfer regions, two gas flows which are directed toward one another and which flow in each case along opposite cylinder inner wall surfaces are guided in the direction of the outlet region formed in each case in said cylinder inner wall surface or cylinder longitudinal half.

5. An engine cylinder, comprising:
two opposite, opposingly driven pistons, wherein in each case one outlet region for exhaust gas and in each case one flow transfer region for fresh gas supplied from the crankcase are formed in the region of the bottom dead center (BDC) of each of the two pistons;
wherein the outlet region and the flow transfer region of each piston are formed in each case in a separate, delimited circumferential portion of the cylinder inner wall;
wherein the two outlet regions for the exhaust gas, which are situated in the respective bottom dead center regions (BDC) of the pistons, are arranged offset with respect to one another by 180° about the cylinder circumference;
wherein the two flow transfer regions for fresh gas which are situated in the respective bottom dead center regions (BDC) of the pistons are arranged offset with respect to one another by 180° about the cylinder circumference; and
wherein each flow transfer region has a number of flow transfer windows which are formed in the cylinder inner wall and by way of which the fresh gas supplied from the crankcase is admitted in a directed manner in the direction of a wall region which is situated on said side of the cylinder inner wall and which adjoins the respective flow transfer region in the cylinder longitudinal direction.

6. The cylinder as claimed in claim 5, wherein the flow transfer windows direct the flow of the fresh gas toward a portion of the wall region of the cylinder inner wall, which portion lies in the central region of said wall surface region.

7. The cylinder as claimed in claim 5, wherein the cylinder exhibits centric symmetry with respect to the respective flow transfer regions and outlet regions assigned to the two pistons.

8. The cylinder as claimed in claim 5, wherein each of the flow transfer windows provided in the two flow transfer regions is delimited by wall surfaces which predefine for the flow transfer windows an outflow direction which runs in the direction of the wall region adjoining the respective flow transfer region.

9. The cylinder as claimed in claim 5, wherein the end surface of each piston is constructed so as to exhibit centric symmetry with respect to the piston longitudinal axis, and/or in that the end surface of the piston is free from local elevations and/or depressions at least in its edge regions, and/or in that the end surface of the piston is planar or concavely curved.

10. The cylinder as claimed in claim 5, wherein ignition units and/or fuel injection units and/or fuel feed units open out in the circumferential region situated in the region of the longitudinal central plane of the cylinder.

11. The cylinder as claimed in claim 5, wherein the cylinder comprises two component cylinders which are of identical and mirror-symmetrical construction with respect to a central plane perpendicular to the cylinder longitudinal axis but which are rotationally offset with respect to one another by 180° about the cylinder longitudinal axis.

12. The cylinder as claimed in claim 5, wherein the flow transfer windows and the outlet windows are formed symmetrically with respect to a longitudinal central plane, which is perpendicular to the piston pin and which encompasses the cylinder longitudinal axis, of the cylinder.

13. The cylinder as claimed in claim 5, wherein the outlet ducts which extend from the outlet regions of the cylinder are connected to an exhaust system, and during the time period in which the outlet ducts are opened up by the respective piston, the pressure waves running in the direction of the silencer and back are in resonance with the opening duration of the outlet windows.

14. The cylinder as claimed in claim 5, wherein a multiplicity of outlet windows is formed in the outlet region.

15. The cylinder as claimed in claim 5, wherein cooling ducts are formed in the wall of the cylinder in the wall webs between the outlet windows and/or the flow transfer windows.

16. An engine, comprising at least one engine cylinder according to claim 5.
